(19) United States
(12) Patent Application Publication
(10) Pub. No.: US 2007/0065194 A1
(43) Pub. Date: Mar. 22, 2007

(54) Fixing device including fixing belt

(75) Inventors: Jeong-wha Kim, Suwon-si (KR); Hwan-guem Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/524,196

(22) Filed: Sep. 21, 2006

(30) Foreign Application Priority Data
Sep. 21, 2005 (KR) 2005-87643

(51) Int. Cl. G03G 15/20

(52) U.S. Cl. 399/329

(57) ABSTRACT

A fixing device includes a heating roller, a pressing roller, a fixing belt for forming a fixing nip, and a belt pressing member which slidably supports and presses the inner circumferential surface of the fixing belt in the entire fixing nip. Since a fixing nip can sufficiently expand and a time that a printable medium passes through the fixing nip can increase, a fixing temperature can be lowered while maintaining image fixing quality, and power consumption and a warming-up time can be reduced. In addition, looseness of the fixing nip due to an air gap can be prevented and thus good image fixing quality can be ensured.

### CROSS-REFERENCE TO RELATED PATENT APPLICATION

This application claims the benefit of Korean Patent Application No. 2005-87643, filed on Sep. 21, 2005 in the Korean Intellectual Property Office, the disclosure of which is incorporated herein in its entirety by reference.

### BACKGROUND OF THE INVENTION

1. Field of the Invention

Aspects of the present invention relate to a fixing device for an image forming apparatus, and more particularly, to a fixing device for an electrophotographic image forming apparatus that fixes a toner image on a printable medium using a fixing belt.

2. Description of the Related Art

In general, an electrophotographic image forming apparatus (such as a printer, copier, or a multi functional peripheral) includes a fixing device for fixing a toner image on a printable medium (such as a sheet of paper or an OHP film) by high temperature and high pressure. FIG. 1 is a cross-sectional side view of a conventional two-roller type fixing device 10. A heating roller 20 includes a heat source 23 that heats the printable medium to a fixing temperature and a pressing roller 30 that contacts the heating roller 20 and presses the printable medium against the roller 20 with a fixing pressure. A fixing nip 40 having a predetermined length is formed at a point where the heating roller 20 and the pressing roller 30 contact each other. A toner image is fixed on the printable medium when the printable medium passes through the fixing nip 40.

In order to prevent a dimensional change of the fixing nip 40 due to high temperature and high pressure, the heating roller 20 and the pressing roller 30 must have sufficient rigidity. In general, the heating roller 20 and the pressing roller 30 respectively include metal pipes 21 and 31 having sufficient thicknesses to afford this rigidity. If the heating roller 20 and the pressing roller 30 are composed of only rigid bodies, vibrations may be generated, such as when irregularities exist on the surface of the printable medium passing through the fixing nip 40, when toner particles are irregular, or when an external mechanical impact is not attenuated. If the length, the contact temperature, and the contact pressure of the fixing nip 40 vary due to the vibrations or the impact, the uniformity of the fixing quality may be reduced. In order to prevent a fixing failure and uniformly maintain the length, the contact temperature, and the contact pressure of the fixing nip 40, elastic layers 22 and 32 made of synthetic resin or rubber are formed on the outer circumferential surfaces of the heating roller 20 and the pressing roller 30, respectively.

If the length of the fixing nip 40 increases, the time of heating and pressing the toner image become longer and thus the fixing quality is improved. Furthermore, since the fixing temperature and pressing force can be set to low values, the lifetimes of the elastic layers 22 and 32 are increased since the temperature rising time of the fixing device 10 can be reduced It therefore becomes possible to perform high-speed printing. The length of the fixing nip 40 is proportional to the outer diameters of the heating roller 20 and the pressing roller 30 and the thicknesses of the elastic layers 22 and 32. If the outer diameters of the heating roller 20 and the pressing roller 30 are large and the elastic layers 22 and 32 are thick, the length of the fixing nip 40 becomes longer, and vibration absorption is improved.

The temperature rising time of the fixing device 10 occupies most of the warming-up time of the image forming apparatus. Accordingly, the temperature rising time of the fixing device 10 should be shortened in order to perform high-speed printing. In the two-roller type fixing device 10, the length of the fixing nip 40 depends on the outer diameters of the rollers 20, 30. That is, if the outer diameters of the rollers 20, 30 are large, the dimensional volume and the heat capacity of the apparatus are large, and thus, the warming-up time becomes longer. In addition, in order to maintain an adequate temperature in a standby mode, large power consumption is required.

Furthermore, if the pressing force increases in order to lengthen the fixing nip 40, the shapes of the elastic layers 22 and 32 are significantly distorted and thus, the durability thereof is deteriorated. Also, movability of the printable medium is worsened and thus, paper jams can be generated. In addition, the driving loads of the rollers 20, 30 increase and thus, mechanical defects may be generated in the image forming apparatus.

FIG. 2 illustrates a belt type fixing device 10′ for addressing the aforementioned problems. This fixing device 10′ includes a fixing belt 50, which travels between a heating roller 20′ and a pressing roller 30′. The fixing belt 50 circulates on the outer circumferential surfaces of the pressing roller 30′ and a support roller 60. A printable medium passes through a fixing nip formed by the fixing belt 50 and the heating roller 20′ to fix a toner image on the printable medium. If the respective rollers 20, 30, 60 rotate in the rotation directions shown in FIG. 2, the printable medium is conveyed from a right side to a left side to fix a toner image on the printable medium. The fixing nip has a length from a point 42, where the support roller 60 and the heating roller 20′ face each other, to a point 41, where the pressing roller 30′ and the heating roller 20′ face each other. Although the outer diameters of the rollers 20, 30, 60 are small, the fixing nip can be sufficiently lengthened by controlling the positions of the rollers 20, 30, 60. At this time, since the fixing nip is formed in a curved surface shape along the outer circumferential surface of the heating roller 20′, a curl may occur in the printable medium due to the high temperature and high pressure. Accordingly, a decurl portion or a means for suppressing the curl (that is, a means for reducing the radius of curvature of the fixing nip), should be further provided. In addition, if the length of the fixing nip increases, the fixing temperature can be further reduced, compared with the two-roller type device shown in FIG. 1. Thus, the temperature rising time of the fixing device 10′ can be shortened, the lifetimes of the elastic layers 22′ and 32′ can be increased, and the fixing quality can be improved.

When the heating roller 20′, the pressing roller 30′, and the support roller 60 rotate, an air layer is formed on the outer circumferential surfaces thereof by air friction. Because only the pressing roller 30′, the heating roller 20′, and the support roller 60 are elastically biased (by an additional elastic member not shown), an air gap g between the belt 50 and the roller 20′ may be generated in the fixing nip, except at the contact points 41 and 42. As the rotation speeds of the heating roller 20′, the pressing roller 30′, and the support roller 60 increase, the size of the air gap g increases. Thus, looseness of the fixing nip becomes serious and a fixing failure may occur.

### SUMMARY OF THE INVENTION

Aspects of the present invention provide a fixing device which prevents an air gap from being generated in a fixing nip formed by a fixing belt to prevent an image fixing failure, lengthens the fixing nip to improve image fixing quality, sets a fixing temperature and a fixing pressure to low values to increase the lifetime of an elastic layer, reduces the dimensional volume of the fixing device to minimize an image forming apparatus, and/or reduce a heat capacity of the fixing device to shorten a temperature rising time and realize high-speed printing.

According to an aspect of the present invention, there is provided a fixing device for an electrophotographic image forming apparatus, including: a heating roller which heats a printable medium while rotating; a fixing belt which circulates and forms a fixing nip with the outer circumferential surface of the heating roller; a pressing roller which presses the inner circumferential surface of the fixing belt while rotating and forms a first nip; and a belt pressing member which slidably supports and presses the inner circumferential surface of the fixing belt and forms a second nip at a portion where the fixing belt is contacted to the heating roller, wherein the fixing nip is consecutively formed by contacting the fixing belt to the heating roller from the first nip to the second nip.

According to another aspect of the present invention, there is provided a fixing device for an electrophotographic image forming apparatus, including: a heating roller which heats a printable medium; a fixing belt which circulates on the outer circumferential surface of the heating roller and forms a fixing nip; a pressing roller which presses the outer circumferential surface of the fixing belt while rotating and forms a first nip; and a belt pressing member which slidably supports and presses the inner circumferential surface of the fixing belt and forms a second nip at a portion where the fixing belt is contacted to the pressing roller, wherein the fixing nip is consecutively formed by contacting the fixing belt to the pressing roller from the first nip to the second nip.

According to another aspect of the present invention, there is provided a fixing device of an electrophotographic image forming apparatus, comprising: a first roller; a second roller; a biasing member that biases the first and second roller against each other to press against a printable medium at a first nip while heating the printable medium; a heating member disposed in at least one of the first and second roller to heat the printable medium to a temperature at which toner fixes to the printable medium; a fixing belt having an outer portion which presses the printable medium along a circumferential edge of one of the first and second roller to form a second nip while being driven to rotate by the other one of the first and second rollers; and a belt pressing member having a shape substantially parallel to a shape of the circumferential edge of the one roller and which slidably supports and presses an inner circumferential surface of the fixing belt to press the printable medium along the circumferential edge of the one roller from the second nip through the first nip.

According to another aspect of the present invention, there is provided an electrophotographic image forming apparatus containing a fixing device as described herein.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and/or advantages of the present invention will become more apparent and more readily appreciated by describing in detail exemplary embodiments thereof with reference to the accompanying drawings in which:

FIG. 1 is a cross-sectional side view of a conventional two-roller type fixing device;

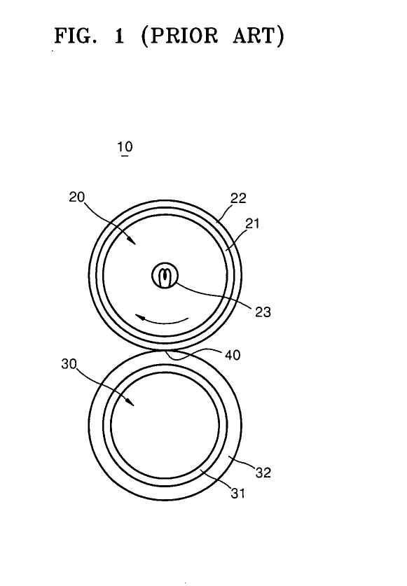

FIG. 2 is a cross-sectional side view of a conventional belt type fixing device;

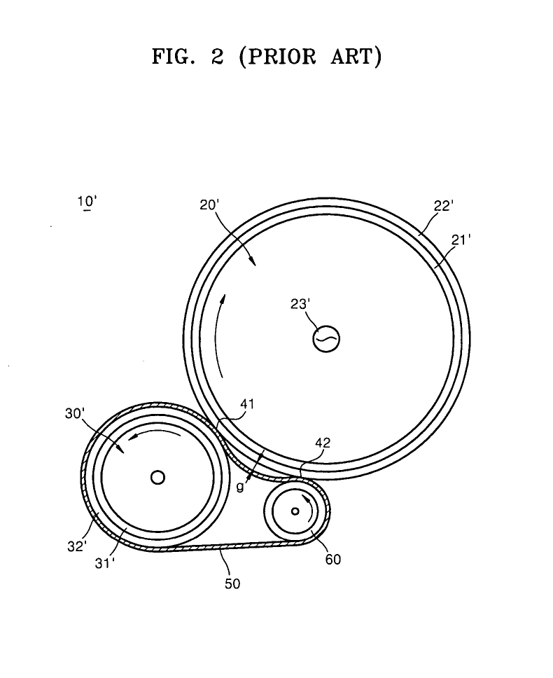

FIG. 3 is a cross-sectional side view of an image forming apparatus including a fixing device according to an embodiment of the present invention;

FIG. 4 is a cross-sectional side view of an image forming apparatus including a fixing device according to another embodiment of the present invention;

FIG. 5 is a cross-sectional view of the fixing device in the image forming apparatus of FIG. 3; and

FIG. 6 is a cross-sectional view of the fixing device in the image forming apparatus of FIG. 4.

### DETAILED DESCRIPTION OF THE EMBODIMENTS

Embodiments of the invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

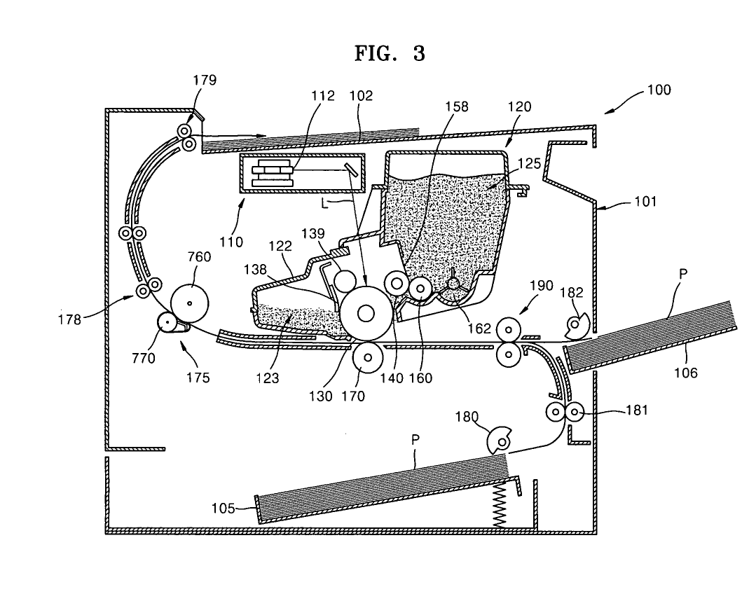

FIG. 3 is a cross-sectional side view of a monochromic image forming apparatus 100 including a fixing device 175 according to an embodiment of the present invention. Referring to FIG. 3, the image forming apparatus 100 includes a print unit for transferring a toner image onto a printable medium P, and the fixing device 175 for fixing the toner image on the printable medium. The print unit includes an image forming apparatus main body 101, a laser scanning unit 110, and a development cartridge 120. While not limited thereto, the printable medium P can be paper, photographic paper, plastic, cards, or other media onto which toner can be transferred.

The laser scanning unit 110 irradiates light L corresponding to image information onto a photosensitive body 130 to form an electrostatic latent image on the outer circumferential surface of the photosensitive body 130. The laser scanning unit 110 includes a light source (not shown) that irradiates a laser beam and a beam deflector 112 that deflects the laser beam irradiated from the light source.

The development cartridge 120 is detachably mounted in the image forming apparatus main body 101. The development cartridge 120 includes a development roller 140, and the photosensitive body 130 facing the development roller 140. A development cartridge housing 122 wraps the development cartridge 120 while allowing the light L to pass to the photosensitive body 130. In the development cartridge housing 122, the photosensitive body 130, a charging roller 139, a cleaning member 138, the development roller 140, a toner layer controlling member 158, a feed roller 160, and an agitator 162 are provided. In addition, a waste toner storing unit 123 for storing waste toner removed from the photosensitive body 130 by the cleaning member 138 and a toner storing unit 125 for storing toner are provided. When the toner stored in the toner storing unit 125 is used up, the development cartridge 120 is replaced with a new cartridge. However, it is to be understood that other types of cartridges 120 can be used and that the cartridge 120 need not be detachable in all aspects, such as where the toner storing unit 125 is refillable.

A portion of the outer circumferential surface of the photosensitive body 130 is exposed and the photosensitive body 130 rotates in a predetermined direction. The photosensitive body 130 has a photoconductive layer coated on the outer circumferential surface of a cylindrical drum, which can be coated by deposition. The photosensitive body 130 is charged to a predetermined potential voltage by the charging roller 139. The electrostatic latent mage corresponding to an image to be printed is formed on the outer circumferential surface of the photosensitive body 130 by the light L irradiated from the laser scanning unit 110.

The development roller 140 contains a powder toner and feeds the toner to the electrostatic latent image formed on the photosensitive body 130 to form a toner image. A development bias voltage for feeding the toner to the photosensitive body 130 is applied to the development roller 140. The outer circumferential surface of the development roller 140 contacts an outer circumferential surface of the photosensitive body 130 to form a development nip or the development roller 140 and the photosensitive body 130 are spaced apart from each other to form a development gap. The development nip or the development gap should be uniformly formed at a predetermined size substantially along the axial directions of the development roller 140 and the photosensitive body 130.

The feed roller 160 feeds the toner to the development roller 140 to adhere the toner onto the outer circumferential surface of the development roller 140. The agitator 162 agitates the toner such that the toner contained in the toner storing unit 125 is not hardened, and conveys the toner toward the feed roller 160. The toner layer controlling member 158 controls the thickness of the toner adhered on the outer circumferential surface of the development roller 140.

A transfer roller 170 faces the outer circumferential surface of the photosensitive body 130. A transfer bias voltage having opposite polarity to the toner image is applied to the transfer roller 170 such that the toner image formed on the photosensitive body 130 is transferred on to the printable medium P. The toner image is transferred onto the printable medium P by an electrostatic force and a mechanical contact pressure generated between the photosensitive body 130 and the transfer roller 170. The cleaning member 138 is mounted in the development cartridge housing 122 and contacts the photosensitive body 130 with a predetermined pressure to collect toner remaining on the photosensitive body 130 after the toner image is transferred.

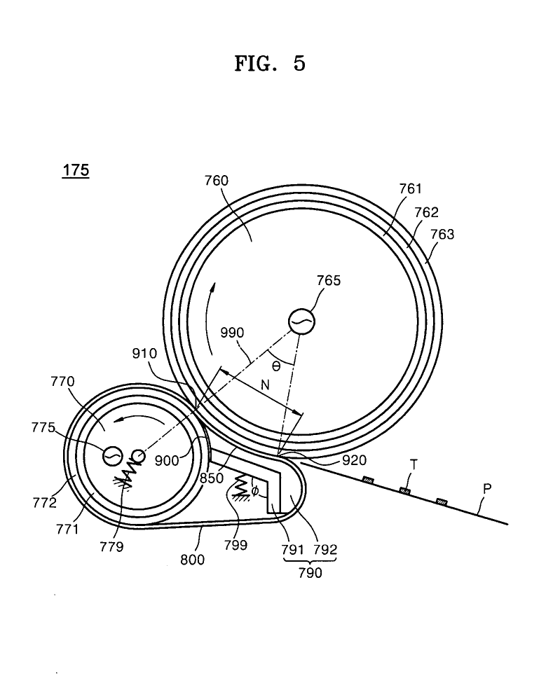

The fixing device 175 included in the image forming apparatus of FIG. 3 is shown in FIG. 5, in which a fixing belt 800 is wound on the outer circumferential surface of a pressing roller 770. The fixing device 175 includes a heating roller 760, the pressing roller 770, and the fixing belt 800, which is wound on the outer circumferential surface of the pressing roller 770 and travels along a continuous path. The toner image is fixed on the printable medium P by applying heat and pressure to the toner image transferred onto the printable medium P. A detailed description of the fixing device according to the embodiment of FIG. 5 will be provided later.

A decurl portion 178 removes a curl of the printable medium P generated by the heat of the fixing device 175. A discharge roller 179 discharges the printable medium P on which the toner image is fixed to the outside of the image forming apparatus 100. The printable medium P discharged from the image forming apparatus 100 is loaded onto a discharge tray 102. However, it is to be understood that ones of the elements can be added, combined, or removed in other aspects of the invention. For instance, the trays 105, 102 need not both be used and/or can be external to the housing 101 in aspects of the invention.

The printable medium P is conveyed as follows. The image forming apparatus 100 includes first and second feed cassettes 105 and 106 in which the printable medium P is loaded. Pickup rollers 180 and 182 pick up the loaded printable medium P one by one. A conveying roller 181 provides a conveying force for conveying the picked-up printable medium P toward a sheet aligner 190. The sheet aligner 190 aligns the printable medium P such that the toner image can be transferred onto a desired portion of the printable medium P before the printable medium P passes between the photosensitive body 130 and the transfer roller 170.

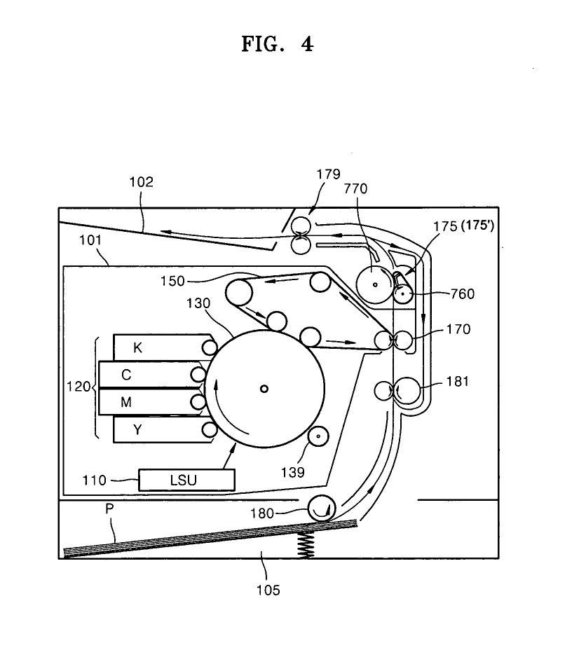

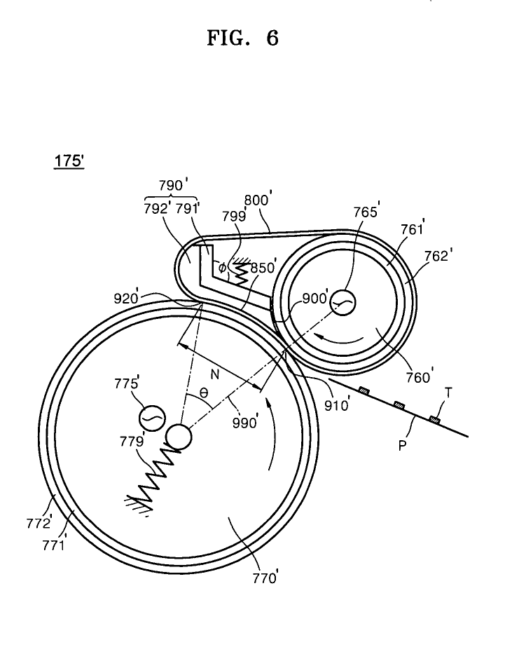

FIG. 4 illustrates a multi-color electrophotographic image forming apparatus including a fixing device according to an embodiment of the present invention. In order to avoid repetition, the description of like elements as those shown in FIG. 3 and the detailed description of the print operation will be omitted. The fixing device 175′ included in the multi-color electrophotographic image forming apparatus of FIG. 4 is shown in FIG. 6, in which a fixing belt 800′ is wound and circulates on the outer circumferential surface of a heating roller 760′. A detailed description on the fixing device 175′ will be described later with reference to FIG. 6.

For multi-color electrophotographic printing, a plurality of development cartridges 120 are used. The multi-pass type image forming apparatus shown in FIG. 4 includes one photosensitive body 130 and four development cartridges 120. For example, four development cartridges 120 for containing respective development agents of black (K), cyan (C), magenta (M), and yellow (Y) are included. The photosensitive body 130 is mounted in an image forming apparatus main body 101 separately from the development cartridges 120. For example, a toner image of yellow (Y) is first formed on an intermediate transfer belt 150. Next, the toner images of cyan (C), magenta (M), and black (K) color are sequentially formed on the intermediate transfer belt 150. Thus, the toner images of four colors sequentially overlap on the intermediate transfer belt 150 to form a multi-color toner image. Next, the printable medium P passes through a transfer nip formed between the transfer roller 170 and the intermediate transfer belt 150 to transfer the toner image onto the printable medium P. A fixing device 175 applies heat and pressure to the non-fixed toner image to fuse the non-fixed toner image on the printable medium P. While described in terms of four cartridges of colors yellow, cyan, magenta, and black, it is to be understood that more or fewer cartridges can be used and that other colors can be used in addition to or instead of the shown colors.

Although not shown, a single-pass type image forming apparatus includes four photosensitive bodies and four development cartridges for containing the respective development agents of four colors. In this image forming apparatus, since exposing, photosensitizing, and developing processes for each color are performed at the same time, high-speed printing can be realized. A two-pass type image forming apparatus is a combination of the multi-pass type and the single-pass type, and includes two unit structures. Each unit structure includes two development cartridges and one photosensitive body.

FIG. 5 illustrates a fixing device according to an embodiment of the present invention. The fixing device 175 includes a pressing roller 770, a heating roller 760, a fixing belt 800 wound on the outer circumferential surface of the pressing roller 770, and a belt pressing member 790. In order to fix a toner image T, a fixing nip must be heated to a predetermined fixing temperature before starting a fixing operation. The heating roller 760 includes a core pipe 761. The core pipe 761 is heated by a heat source 765. The heating roller 760 includes an elastic layer 762 laminated on the outer circumferential surface of the core pipe 761 and forms the fixing nip. The heating roller 760 further includes a release layer 763 on the outer circumferential surface of the elastic layer 762 such that the toner image T is not adhered thereto by heat and pressure. However, it is to be understood that the release layer 763 is not required in all aspects of the invention.

According to an aspect of the invention, the material of the core pipe 761 includes a stainless steel alloy, maraging steel, and an aluminum alloy. The maraging represents aged martensite. An example of maraging steel is a steel alloy of Fe—Ni—Co—Mo that contains 18 to 25% nickel and has a tensile strength of 175 to 210 (kg/mm²) and excellent toughness and producibility. While not required, the maraging steel can be 18 nickel-8 cobalt-5 molybdenum steel (18% nickel steel), 20 nickel-1.5 titanium-0.45 niobium steel (20% nickel steel), and 25 nickel-1.5 titanium-0.45 niobium steel (25% nickel steel). The 18% nickel steel has an excellent material property and is most widely used. While not required, the aluminum alloy can be an aluminum alloy of alloy No. 2000 series (Al—Cu, Al—Cu—Mg) (for example, Al 2011, Al 2014, Al 2017, and Al 2024), an aluminum alloy of alloy No. 6000 series (Al—Mg—Si) (for example, Al 6061 and Al 6063), and/or an aluminum alloy of alloy No. 7000 series (Al—Zn—Mg—Cu) (for example, Al 7003, Al 2014 and Al 7075). Zn, Mg, Cu, and Si improve a mechanical property of aluminum.

According to an aspect of the invention, the pipe 761 is subjected to a heat treatment using a heating method. There are various heating methods for the core pipe 761. In one of the heating methods, the core pipe 761 is thermally treated in the fabrication process such that the strength of the core pipe 761 has a maximum value. However, during the lifetime of the image forming apparatus, there is a time duration for which the fixing device is maintained at a high fixing temperature (for example, the temperature of the outer surface of the heating roller 760 is maintained at about 150 to 250° C.). Although the heat treatment is not generally performed in the fabricating process, an aging treatment of the core pipe 761 may be performed at a fixing temperature while the core pipe 761 is assembled and used in the fixing device.

Alternatively, a pre-aging treatment may be performed in the process of fabricating the core pipe 761 and a remaining aging treatment may be performed at a fixing temperature while the core pipe 761 is assembled and used in the fixing device. These heating treatments reinforce the strength of the core pipe 761 and reduce the time and cost of the fabricating process.

While not required in all aspects, the material of the elastic layer 762 can be silicon rubber, urethane, expandable resin, and/or fluororubber. The heat source 765 includes a heat coil for generating Joule's heat and/or a halogen lamp generating radiant energy. Radiant energy generated by the halogen lamp is converted into heat energy by a light/heat converting layer (not shown) provided on the inner circumferential surface of the core pipe 761. The core pipe 761 is heated by the heat energy and the temperature of the elastic layer 762 laminated on the outer circumferential surface of the core pipe 761 increases to a predetermined fixing temperature by heat conduction. A temperature controller (not shown) for maintaining a uniform fixing temperature is further included. A temperature sensor (not shown) for controlling the temperature is placed to contact or not contact the outer circumferential surface of the heating roller 760.

The pressing roller 770 is elastically biased by an elastic member 779 and presses the inner circumferential surface of the fixing belt 800 against the heating roller 760 with a predetermined fixing pressure. The printable medium P, on which the toner image T is formed, is conveyed to the fixing device by a print unit and the printable medium P is heated to a predetermined fixing temperature and pressurized at a predetermined fixing pressure in the fixing nip such that the toner image T is fused on the printable medium R As shown, heat source 775 for heating the core pipe 771 of the pressing roller 770 is further included in the pressing roller 770. Since the heat source 775 provided in the pressing roller 770 is substantially identical to the heat source 765 provided in the heating roller 760, its description will be omitted. The pressing roller 770 includes a core pipe 771 made of metal, and an elastic layer 772 laminated thereon, similar to the heating roller 760. The materials and the functions of the core pipe 771 and the elastic layer 772 included in the pressing roller 770 are substantially identical to those of the core pipe 761 and the elastic layer 762 included in the heating roller 760, and thus their description will be omitted. However, it is to be understood that the heat source 775, the core pipe 771, and/or the elastic layer 772 need not be used in all aspects of the invention.

The outer circumferential surface of the fixing belt 800 contacts the outer circumferential surface of the heating roller 760 to form the fixing nip. The shown fixing nip is formed in a circular arc shape having a contact angle θ relative to a central axis of the roller 760. The length of the circular arc is N. One end of the fixing belt 800 is supported by the pressing roller 770 and the other end thereof is supported by a belt pressing member 790. Both ends of the fixing belt 800 are supported in an expanded state by the pressing roller 770 and the belt pressing member 790. If it is possible to form successive fixing nips, an additional support member (not shown) for supporting the fixing belt 800 may be provided in addition to the pressing roller 770 and the belt pressing member 790 according to an aspect of the invention.

The pressing roller 770 presses the inner circumferential surface of the fixing belt 800 to form a first nip 910. The first nip 910 is formed at a position where the pressing roller 770 and the heating roller 760 face each other at a shortest distance. The position is located along an imaginary line 990 which connects the rotation centers of the pressing roller 770 and the heating roller 760.

The belt pressing member 790 includes a support portion 791 and an elastic portion 792. As shown in the example in FIG. 5, the belt pressing member 790 is provided at an upstream side of a fixing region, that is, an upstream side of the imaginary line 990 which connects the rotation centers of the pressing roller 770 and the heating roller 760 with each other. However, the belt pressing member 790 may be provided at a downstream side of the fixing region in another embodiment. In this case, although not illustrated, the belt pressing member 790 is positioned to be axisymmetric with respect to the imaginary line 990. Although not shown, at least two belt pressing members 790 may be provided at both the upstream side and the downstream side of the imaginary line 990 in other embodiments.

The elastic portion 792 is laminated on the support portion 791 and elastically supports the inner circumferential surface of the fixing belt 800. The support portion 791 is a base on which the elastic layer 792 is laminated, and is elastically biased in a direction to press the fixing belt 800. In the shown embodiment, the support portion 791 is elastically supported by the elastic member 799. However, other mechanisms can be used to bias, such as springs and/or a resilience of the portion 792. Additionally, it is to be understood that the elements 791, 792 could be combined in a single material in other aspects of the invention.

The belt pressing member 790 slidably supports the inner circumferential surface of the fixing belt 800 and closely adheres the fixing belt 800 to the heating roller 760. A second nip 850 is formed at a portion where the fixing belt 800 is closely adhered to the heating roller 760. The second nip 850 has a length from a point 920 where the other end of the fixing belt 800 starts to contact the heating roller 760 to the first nip 910. The fixing nip includes the first nip 910 and the second nip 850. The belt pressing member 790 continuously presses the fixing belt 800 from the first nip 910 to the second nip 850 to closely adhere the fixing belt 800 to the heating roller 760 along the entire fixing nip. The belt pressing member 790 is provided in the inner circumferential surface of the fixing belt 800 together with the pressing roller 770.

A slope portion 900 closely adhered to the outer circumferential surface of the pressing roller 770 is provided at one front end of the belt pressing member 790. If it is satisfied that the inner circumferential surface of the fixing belt 800 is pressurized in the whole fixing nip, the shape of the slope portion 900 may be a plane or a curved surface. For example, the shown slope portion 900 has a circular arc shape having substantially the same curvature radius as the pressing roller 770. The slope portion 900 closely adhered to the outer circumferential surface of the pressing roller 770 slidably contacts the pressing roller 770. In order to prevent an excessive driving load, a lubricant may be added to a portion where the slope portion 900 slidably contacts the pressing roller 770. In order to make the fixing belt 800 smoothly travel, a rounding portion for bending the fixing belt 800 in a curve shape is provided at the other front end of the belt pressing member 790. In addition, the support portion 791 may have a portion which is bent at an obtuse angle in the rounding portion. The shown support portion 791 has an offset angle (φ) of 90° to 180° at the rounding portion. However, it is to be understood that the slope portion 900 need not be used where the member 790 does not contact the roller 770.

A warming-up time for heating the fixing device to a predetermined fixing temperature is generally required. It is necessary to reduce the warming-up time to realize high-speed printing. The fixing device according to the shown embodiment of the present invention can sufficiently expand the fixing nip by adjusting the contact length of the fixing belt 800 without increasing the outer diameters of the pressing roller 770 and the heating roller 760 and without creating an air gap. With an expanded fixing nip, since the time that the printable medium P passes through the fixing nip increases, the fixing temperature can be lowered while maintaining the fixing quality and the warming-up time can be reduced. If the fixing temperature is decreased, the lifetime of the elastic layer 772 increases, the warming-up time is reduced, and the power consumption is reduced. The fixing device having the fixing belt 800 can allow the diameters of the rollers 760, 770 to be minimized, and can thus reduce a temperature rising time by reducing a heat capacity.

FIG. 6 illustrates a fixing device according to another embodiment of the present invention. Referring to FIG. 6, the fixing device 175′ includes the heating roller 760′, a pressing roller 770′, the fixing belt 800′ wound on the outer circumferential surface of the heating roller 760′, and a belt pressing member 790′. The description of like elements to those shown in FIG. 5 will be omitted. The fixing belt 800′ is wound on the outer circumferential surfaces of the heating roller 760′ and the belt pressing member 790′. As shown in FIG. 6, the belt pressing member 790′ is provided at a downstream side on the basis of an imaginary line 990′ which connects the rotation centers of the pressing roller 770′ and the heating roller 760′ with each other. Although not illustrated, the belt pressing member 790′ may be provided at an upstream side of the imaginary line 990′ in another aspect of the invention. In this case, the belt pressing member 790′ is positioned to be axisymmetric with respect to the imaginary line 990′. Although not illustrated, at least two belt pressing members 790′ may be provided at both the upstream side and the downstream side of the imaginary line 990′ in another aspect of the invention.

The pressing roller 770′ is elastically biased by an elastic member 779′ and presses one end of the fixing belt 800′ to form a first nip 910′. The first nip 910′ is formed at a position where the pressing roller 770′ and the heating roller 760′ face each other at a shortest distance through the fixing belt 800′, in an imaginary line 990′ which connects the rotation centers of the pressing roller 770′ and the heating roller 760′. The belt pressing member 790′ slidably supports and presses the other end of the fixing belt 800′ to closely adhere the fixing belt 800 to the outer circumferential surface of the pressing roller 770′.

The belt pressing member 790′ receives an elastic force toward the pressing roller 770′ from the elastic member 799′. A second nip 850′ is formed at a portion where the fixing belt 800′ is closely adhered to the pressing roller 770′. The second nip 850′ has a length from a point 920′ where the other end of the fixing belt 800′ starts to be separated from the pressing roller 770′ to the first nip 910′. The belt pressing member 790′ consecutively presses the fixing belt 800′ from the first nip 910′ to the second nip 850′. A fixing nip includes the first nip 910′ and the second nip 850′, and has a circular arc shape having a circumferential length N′ and a contact angle θ′.

A slope portion 900′ closely adhered to the outer circumferential surface of the heating roller 760′ is provided at one front end of the belt pressing member 790′. The slope portion 900′ may be closely adhered to the outer circumferential surface of the heating roller 760′ while slidably contacting the heating roller 760′. In order to smoothly travel the fixing belt 800′, a rounding portion for bending the fixing belt 800′ is provided at the other front end of the belt pressing member 790′. In order to reduce a temperature rising time, a heat source 775′ for heating the core pipe 771′ of the pressing roller 770′ may be included in the pressing roller 770′.

As described above, according to examples of the fixing device of the present invention, although the outer diameters of a pressing roller and a heating roller do not increase, a fixing nip can sufficiently expand by controlling the contact length of a fixing belt without causing an air gap. Furthermore, since the time during which a printable medium passes through the fixing nip increases, the fixing temperature can be lowered while maintaining image fixing quality. Thus, the lifetime of an elastic layer increases, power consumption can be reduced, and the warming-up time can be reduced. Moreover, the fixing device can be minimized by reducing a heat capacity of the fixing device and a temperature rising time can be reduced. In addition, looseness of the fixing nip due to an air gap can be prevented and thus good image fixing quality can be ensured.

While aspects of the present invention has been particularly shown and described with reference to exemplary embodiments thereof, it will be understood by those of ordinary skill in the art that various changes in form and details may be made therein without departing from the spirit and scope of the present invention as defined by the following claims, and equivalents thereof.

What is claimed is:

1. A fixing device for an electrophotographic image forming apparatus comprising:
a heating roller which heats a printable medium while rotating;
a fixing belt which circulates and forms a fixing nip with the outer circumferential surface of the heating roller, the fixing nip extending continuously along the outer circumferential surface of the heating roller from a first nip to a second nip;
a pressing roller which presses an inner circumferential surface of the fixing belt while rotating and forms the first nip; and
a belt pressing member which slidably supports and presses the inner circumferential surface of the fixing belt and forms a second nip at a portion where the fixing belt is pressed to contact the heating roller.

2. The fixing device according to claim 1, wherein the belt pressing member further comprises a slope portion that contacts the outer circumferential surface of the pressing roller.

3. The fixing device according to claim 2, wherein the slope portion slidably contacts the outer circumferential surface of the pressing roller.

4. The fixing device according to claim 3, wherein the belt pressing member further comprises a rounding portion that bends the fixing belt.

5. The fixing device according to claim 4, wherein the belt pressing member comprises:
a support portion which is elastically biased in a direction to press the fixing belt; and
an elastic portion which is laminated on the support portion and elastically contacts the inner circumferential surface of the fixing belt.

6. The fixing device according to claim 5, wherein the support portion has an offset angle of 90° to 180° at the rounding portion.

7. The fixing device according to claim 6, wherein the fixing belt is supported in an expanded state by the pressing roller and the belt pressing member.

8. The fixing device according to claim 1, wherein each of the heating roller and the pressing roller comprises:
a core pipe made of metal; and
an elastic layer provided on the outer circumferential surface of the core pipe.

9. The fixing device according to claim 8, wherein the heating roller further comprises a release layer on the outer circumferential surface of the elastic layer such that a toner image of the printable medium is not adhered to the outer circumferential surface thereof.

10. The fixing device according to claim 8, further including a heat source that heats the core pipe of the pressing roller.

11. A fixing device of an electrophotographic image forming apparatus, comprising:
a heating roller which heats a printable medium;
a fixing belt which circulates on the outer circumferential surface of the heating roller and forms a fixing nip, the fixing nip including a first nip and a second nip;
a pressing roller which presses the outer circumferential surface of the fixing belt while rotating and forms a first nip; and
a belt pressing member which slidably supports and presses the inner circumferential surface of the fixing belt and forms a second nip at a portion where the fixing belt is pressed to contact the pressing roller,
wherein the fixing nip extends continuously along an outer circumferential surface of the pressing roller from the first nip to the second nip.

12. The fixing device according to claim 11, wherein the belt pressing member further comprises a slope portion that contacts the outer circumferential surface of the heating roller.

13. The fixing device according to claim 12, wherein the slope portion slidably contacts the outer circumferential surface of the heating roller.

14. The fixing device according to claim 13, wherein the belt pressing member further comprises a rounding portion that bends the fixing belt.

15. The fixing device according to claim 14, wherein the belt pressing member comprises:
a support portion which is elastically biased in a direction to press the fixing belt; and
an elastic portion which is laminated on the support portion and elastically contacts the inner circumferential surface of the fixing belt.

16. The fixing device according to claim 15, wherein the support portion has an offset angle of 90° to 180° at the rounding portion.

17. The fixing device according to claim 16, wherein the fixing belt is supported in an expanded state by the heating roller and the belt pressing member.

18. The fixing device according to claim 11, wherein each of the heating roller and the pressing roller comprises:
a core pipe made of metal; and
an elastic layer provided on the outer circumferential surface of the core pipe.

19. The fixing device according to claim 18, further including a heat source that heats the core pipe of the pressing roller.

20. A fixing device of an electrophotographic image forming apparatus, comprising:
a first roller;
a second roller;
a biasing member that biases the first and second roller against each other to press against a printable medium at a first nip while heating the printable medium;
a heating member disposed in at least one of the first and second roller to heat the printable medium to a temperature at which toner fixes to the printable medium;
a fixing belt having an outer portion which presses the printable medium along a circumferential edge of one of the first and second roller to form a second nip while being driven to rotate by the other one of the first and second rollers; and
a belt pressing member having a shape substantially parallel to a shape of the circumferential edge of the one roller and which slidably supports and presses an inner circumferential surface of the fixing belt to press the printable medium along the circumferential edge of the one roller from the second nip through the first nip.

21. An electrographic image forming apparatus comprising
a development cartridge that creates a toner image on a printable medium, and
a fixing device that fixes the toner image on the printable medium,
wherein the fixing device is the fixing device of claim 1.

22. An electrographic image forming apparatus comprising
a plurality of development cartridges and an intermediate transfer belt that create a multi-color toner image on a printable medium, and
a fixing device that fixes the toner image on the printable medium,
wherein the fixing device is the fixing device of claim 11.

23. An electrographic image forming apparatus comprising
a development cartridge that creates a toner image on a printable medium, and
a fixing device that fixes the toner image on the printable medium,
wherein the fixing device is the fixing device of claim 20.
